(19) United States
(12) Patent Application Publication
(10) Pub. No.: US 2009/0272763 A1
(43) Pub. Date: Nov. 5, 2009

(54) DISPENSER WITH A BAG INSIDE AND METHOD FOR MANUFACTURING OF THE SAME

(76) Inventors: Annika Hasselstrom, Vilbdjerg (DK); Ivan Hasselstrom, Vildbjerg (DE)

Correspondence Address: ANDERSON, KILL & OLICK, P.C., 1251 AVENUE OF THE AMERICAS, NEW YORK,, NY, 10020-1182, US

(21) Appl. No.: 12/083,161

(22) PCT Filed: Sep. 5, 2006
(86) PCT No.: PCT/DK2006/000489

§ 371 Date: Mar. 5, 2008

(51) Int. Cl. B65D 35/28; B65D 35/56; B23P 11/00

(52) U.S. Cl. 222/104; 222/105; 29/428

(57) ABSTRACT

A dispenser where a container (1) is provided which container (1) contains an opening (2) at the first end and an end piece (9) at the opposite end (7) and with a container wall (5) a bag (S) is inserted into this volume in the container (1), the bag (6) is attached to the end piece (9), the bag (6) is provided with an opening in the first end and is attached to this open end at the operating of the container the end piece (9) is provided with a radially inward or outward directed ring-shape profile (10), the container wall (5) is provided with a profile or circular opening (11), which is complementary relative to the end piece ring-shaped profile (10), the end piece (9) by elastic deformation is squeezed together with the container wall (5) in such a manner that its profile interacts with the complementary profile (11) or opening of the container wall and hence is arranged to maintain the end piece rotatable to the container wall.

### FIELD OF THE INVENTION

The present invention relates to a dispenser for viscous materials, where the dispenser comprises a container comprising a bag of flexible material, where the bag has an opening in one end, which is attached to an opening in the container for extraction of the material from the bag, where the container has an end piece in the opposite end and an enclosing container wall between the two ends, where the end piece is rotatable in relation to the container wall and where the other end of the bag is attached to the end piece with fastening means such that the bag, when the end pieces are rotated in relation to the container wall, is twisted about its longitudinal axis. The invention also relates to a method for the manufacturing of such dispenser.

### DESCRIPTION OF THE PRIOR ART

A number of dispensers are known wherein a container contains a bag, which by turning of an end piece is twisted about its longitudinal axis to force viscous material out of the bag, e.g. shaving foam or toothpaste.

Such dispensers are described in the patent specifications such as FR 2.801.040 by Didier, FR 801.888 by Samzun FR 1.161.905 by Clair, U.S. Pat. No. 2,234,857 by Thorn and DE 2.638.328 by Bücheler. The dispensers according to these specifications are expensive to manufacture.

### DESCRIPTION OF THE INVENTION

Hence, it is the object of the invention to provide a cheap and simple method for manufacturing of a dispenser and to provide a dispenser which is cheap and easy to manufacture.

This can be achieved with a method for manufacturing of a dispenser according to the invention, the method comprising
providing a container with an opening a the first end and an end piece at the opposite end and with a container wall between the first and the second end, the container wall enclosing a volume,
inserting a bag into this volume in the containers,
attaching the bag to the end piece,
providing the bag with an opening in the first end and attaching the bag with this open end to the opening of the container intended to extraction of material from the bag,
providing the end piece rotabably relatively to the container wall to twist the bag about its longitudinal axis by rotating the end piece in relation to the container wall, wherein
the end piece is provided with a radially inward or outward directed ring-shape profile,
   the end piece by elastic deformation is squeezed together with the container wall in such a manner that its profile interacts with the complementary profile or opening of the container wall and hence is arranged to maintain the end piece rotatable to the container wall.

This way, the end piece is rotatably provided relative to the container wall such that the bag by turning of the end piece relative to the container wall is twisted about its longitudinal axis.

By means of such method the dispenser may be manufactured by simple means, e.g. by plastic moulding according to which the end piece and the container wall by means of a kind of snap lock are combined afterwards. Combination of the materials by means of a snap lock requires a certain material elasticity. The shape of the profiles meaning form and depth/height will be adapted to the elasticity of the material. Accordingly, use of a plastic container requires more distinct profiles than use of a metal container with a metal end piece.

Accordingly, the invention also relates to a dispenser for viscous materials, wherein the dispenser comprises a container containing a bag made of a flexible material, where the bag has all opening in the one end which is attached to an extraction opening in the container for extracting the material from the bag. The container has an end piece in the opposite end and an enclosing container wall between the two ends, where the end piece is turnable relative to the container wall, and where the other end of the bag is attached to the end piece by means of fastening means, such that by turning of the end piece relative to the container, wall the bag is twisted about its longitudinal axis. According to the invention the end piece has a radially inward or outward directed, ring-shaped profile, and the container wall has a profile or a circular opening, which is complementary relative to the end piece ring-shaped profile. Hence, the end piece profile interacts with the container wall complementary profile or opening and thus it is arranged to maintain the end piece rotatable to the container wall.

When applying plastic moulding, it is particularly advantageous to provide the container with two complementary inward or outward directed, ring-shaped profiles in extension of each other in the container wall and a bottom in extension of the profiles, and subsequently to release the end piece from the rest of the container, such that the container is provided with a container wall comprising of one of the two profiles and an end piece comprising of the bottom and the other complementary profile. This way, the end piece ca by elastic deformation, be squeezed together with the container wall in such a manner that its profile interacts with the complementary profile, and it can be arranged to maintain the end piece rotatable to the container wall. Such dispenser can be manufactured in a simple and at low expenses, as the container in combination with the end piece is manufactured in a pre-activated state through a first process, and afterwards the dispenser is modified through another process into an activated state, e.g. by cutting the end piece from the rest of the container and then snap lock it onto the container wall.

Accordingly, the invention also relates to a dispenser which in a pre-activated state comprises a container wall having two radially inward or outward directed, ring-shaped profiles in extension of each other and an end piece, which is fixed to the container wall, and where the container in an activated state has an end piece with a ring-shaped profile and a container wall with a ring-shaped profile, where the end piece profile interacts with the container wall profile to maintain the end piece rotatable to the container wall.

As an example the end piece may be released from the rest of the container by cutting, while the bag is extended in the container to give a large distance to the container wall during the cutting. This way, it is prevented that the bag is damaged unintentionally. Hereafter the end piece is forced over the container wall or into the container wall such that the two ring-shaped, complementary profiles interact to maintain the end piece to the container wall during rotation of the end piece. Ring-shaped profile means e.g. a recess or outward directed bend or torus bead.

Alternatively, the bottom can be released, e.g. it can be cut free from the container wall and be mounted onto the container before attaching the bag to the container.

According to prior art very strong stretchable bags or bottoms are used, which bags or bottoms follow the container when the container is emptied in order to reach a satisfactory twist. However, this has turned out to be unnecessary.

If the size of the bag in the container is adequate, the twisting does not constitute a problem, even in case of materials, such as plastic, which are unstretchable or only slightly extensible. For instance the bag may expand before it is attached to the top and thus reach the correct length. Thus, it is advantageous that the material inside the bag under atmospheric pressure is capable of enclosing a volume, which is larger than the volume of the container. This means that the volume of the bag may increase to be equal to or larger than the internal volume of the container, if the bag is removed from the container.

To ensure that the bag really has a large volume inside the container, it is advantageous to blow gas into the bag to force the bag against the inner wall of the container prior to attaching the bag opening to the container opening. Alternatively, the bag can be sucked against the inside of the container wall by means of vacuum technology.

With previous models, untwisting of the bags is a problem, which is also due to too small or too stretchable bags.

This problem is solved by the invention, as the diameter of the end piece is so much larger than the transverse extension of the bag attachment in the end piece, such that the moment of force by the interacting profiles between the end piece and the container wall is larger than the moment of force acting on the end piece from the bag and thus backwards twisting is prevented. In case the diameter of the interacting ring-shaped profiles is not much larger than the extension of the bag attachment in the end piece, sufficient friction can be provided by goal oriented design of the tightening force between the interacting profiles to counteract backwards twisting. Furthermore, an internal bag can be provided, which is large enough to prevent the occurrence of longitudinal tensions during emptying which contribute to backwards twisting. It should be noted that the expanded bag also is maintained against the inner wall of the container due to the pressure against the inner wall from the content of the bag.

One way of ensuing that the twisting begins in the right end is achieved in that the fastening means at the end piece are arranged to maintain the bag over an extension, which is considerably smaller than the internal cross section of the container in case of a bag of which the extension is larger than extension of the container.

One way of ensuring that the bag does not turn at the wrong end at the spout is to provide the material of the bag with a suitable cross section, which, at least in a distance from the end piece, e.g. at the end at which the viscous material is extracted, has a cross section, which under atmospheric pressure is at least as large as the internal cross section of the container to enable the bag to abut against the inner side of the container. This means that the bag, if it is removed from the container, is capable of having a cross section equal to or larger than the container. This can be achieved with a bag having a volume larger than the container. Since the bag abuts against the inner side of the container causing large fiction against the inner wall of the container, the bag will not have a tendency to twist, and thus the twisting starts in the end in which the end piece is provided.

Strictly speaking, this aspect with a bag having a volume that is larger than the container is not necessary to prevent the bag from twisting backwards. It has proven sufficient that the friction torque, which means the integrated product of the friction and the distance to the axis of rotation, is larger than for the attachment at the bottom piece. The lower friction torque at the bottom piece causes the bag to be twisted backwards from that end. By way of example, a lower friction torque at the bottom piece may be provided with a bag, which narrows against the end piece, as the bag near the end piece will not abut against the inner wall of the container, and during turning of the bottom piece, this part will start the twisting.

In case of bags that do not abut against the inner wall of the container, a solution is that the fastening means at the end pieces are arranged to maintain tie bag over an extension smaller than the diameter of the area, e.g. the opening of the container to which the bag is attached. Hence, the bag will tend to twist in the narrow end of the bag at the end piece in stead of in the wide end at the extraction opening.

If the container has a narrow neck, a bag having a diameter equal to or larger than the interior diameter of the container wall will fold in the extracting opening of the container. This may result in too thick layers of bag material when attaching tile bag to the neck, typically by melting. To avoid this kind of problems, the bag has in a further embodiment according to the invention an extension/diameter that is smaller than or equal to the extension/diameter of the extraction opening, so that foldings are prevented. For nevertheless to have the bag filling out the container, the bag can during heating and gas pressure, for instance during heating with warm air, expand to reach contact with the inner wall of the container.

Alternatively, the bag can be manufactured with a profile corresponding to the container, into which the bag is to be inserted e.g. a container with a narrow neck.

A dispenser according to the invention is suitable for all types of viscous materials and is especially intended for use in connection with food products.

As it appears from the above, it is advantageous that the material of the bag under atmospheric pressure is capable of enclosing a volume larger than the inner volume of the container. This means that the bag may be expanded to have a volume which is equal to or larger than the internal volume of the container, if the bag is removed from the container. This fact may also be applied with other dispensers than he one according to the invention. The fact may, for instance, also improve prior art, as the very extensible bags and the upward-sliding bottoms can be prevented. Accordingly, this means that an improvement in relation to prior art is achieved, if a dispenser for viscous materials is provided, where the dispenser comprises a container containing a bag made of a flexible material, where the bag has an opening in that end that is attached to an opening in the container for extraction of material from the bag, where the container has an end piece in the opposite end and an enclosing container wall between the two ends, where the end piece is rotatable relative to the container wall, and where the other end of the bag is attached to the end piece by means of fastening means such that by turning of the end piece relative to the container wall, the bag is twisted about is longitudinal axis, and wherein the improvement relates to the fact that the material of the bag under atmospheric pressure is capable of enclosing a volume larger than the interior volume of the container.

It should be noted that the dispenser according to the invention can be provided with a replaceable bag. This way, it is not necessary to replace the entire dispenser when the bag is empty, thus, the dispenser can be reused and existing dispensers can be reused with a refill bag. Hence, the customer can purchase a bag to the dispenser and attach the bag correctly to obtain the intended effect as previously described. The bag can e.g. be attached by means of Velcro® connectors, hooks, interacting rails, pushbuttons, clips or squeeze devices.

### SHORT DESCRIPTION OF THE DRAWINGS

In the following the invention is described with reference to the drawings, where

FIG. 1 shows the dispenser according to the invention,

FIG. 2 shows the dispenser according to the invention, where the inner bag is twisted,

FIG. 3 shows the manufacture of a bag and insertion into the dispenser,

FIG. 4 shows an alternative method of inserting the bag,

FIG. 5 shows the attachment of the bag to the end piece,

FIG. 6 shows an alternative attachment to the end piece

FIG. 7 shows the expansion of the bag inside tie dispenser by means of air,

FIG. 8 illustrates attachment of the bag to the dispenser opening in the one end,

FIG. 9 shows an alternative embodiment with an oval-shaped bottle,

FIG. 10 shows different alternative end piece solutions,

FIG. 11 shows an embodiment with a fungus-shaped snap lock,

FIG. 12 shows another embodiment with a fungus-shaped snap lock.

### DETAILED DESCRIPTION OF THE INVENTION

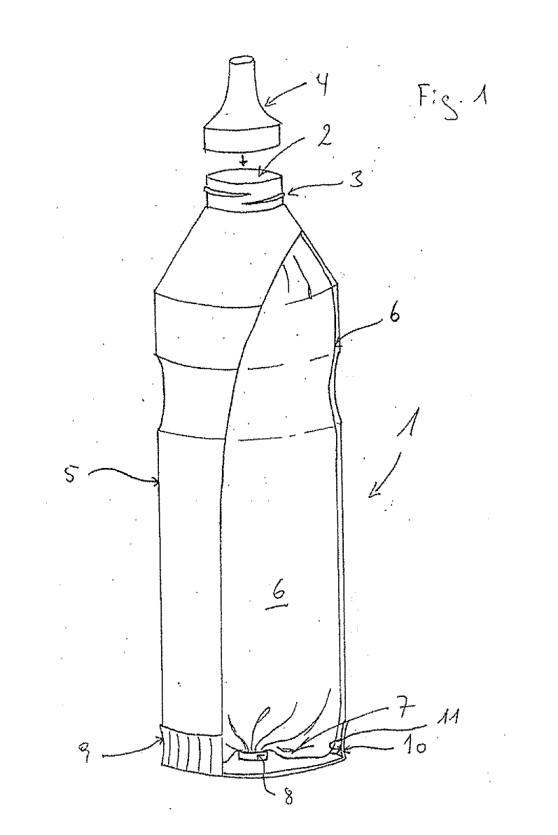

FIG. 1 shows a dispenser in the shape of a bottle 1 intended for viscous materials such as fluids or foodstuffs, e.g. remoulade, mayonnaise, ketchup, mustard and viscous milk products. The bottle 1 has an upper opening 2 with an outer thread 3 for screwing on a spout 4. Alternatively, a similar spout can be pressed on a press edge in the upper part of the bottle 1.

The container wall 5 of the bottle is shown partly cut up to expose the inside of the bottle. Inside the bottle 1 a bag 6 is provided, which bag 6 has an upper opening (not shown) at the bottle 1 opening 2. At the opposite, lower end 7, the bag 6 is gathered in a fixed joint 8, which is fastened to the bottle 1 end piece, where the end piece 9 has a bottom. The end piece 9 has an inward-pointing, ring-shaped torus bead/profile 10 interacting with the dispenser wall 5 complementary bead/profile to achieve a rotatable and yet fixed end piece 9.

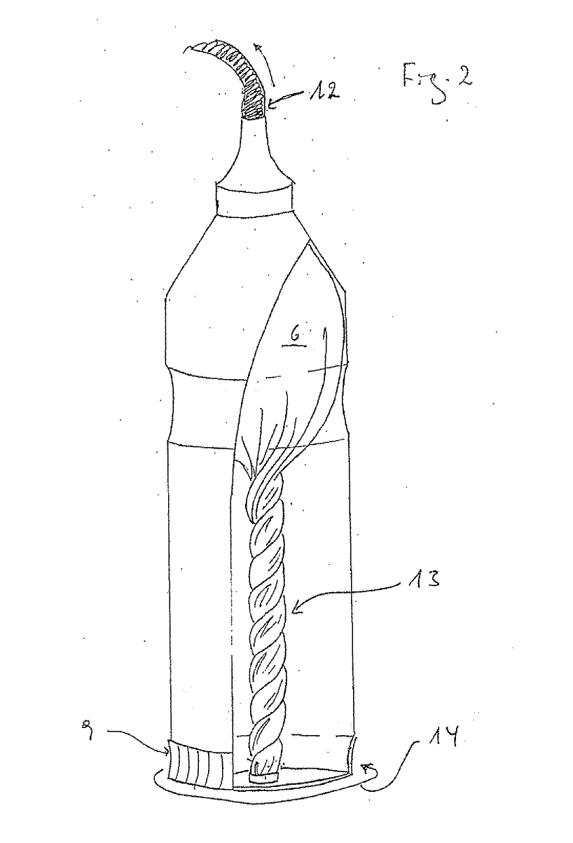

When the end piece 9 is turned, which is illustrated by arrows 14, the bag 6 is automatically twisted 13 from the bottom and upwards, whereby the content 12 of the bag easily is forced out of the bottle spout 4, which is illustrated in FIG. 2. The bottle 1 according to the invention is easily handled. One aims with the bottle 1 spout 4 towards the spot, where the content is to be placed, and rotates the end piece 9, whereby the content easily escapes the bottle 1. The speed depends on the speed of turning. If one wishes to stop the jet, the rotation is stopped, and possibly reversed slightly in the opposite direction. During rotation, the inner bag 6 is twisted from the bottom and up as shown in FIG. 2. By means of the selected construction, the twist rests and the end piece 9 is not turned in the opposite direction. When the twist has reached the bottle top, the bottle is practicably empty.

The intention of the bottle according to the invention is to solve the well-known problem connected with emptying fluids from a bottle and in that connection avoid shaking, squeezing, knocking, spluttering and the wasting of the fluid. Furthermore, the invention ensures that the entire content escapes the bottle. Another side-benefit is the use of fewer additives to increase the durability, as air, and thus bacteria, is not sucked into the bottle. The content acts as an air closure in the bottle top

As an inner bag 6 is used, i.e. an extra layer of plastic, it is possible to use cheaper plastic for the outside dispenser wall 5 without affecting the durability of the content. The dispenser according to the invention not only tales into account the fact that a number of preservatives/additives can be avoided in the foodstuff, and is also more environmentally friendly and involves low risk of allergy.

The invention relates to a procedure for manufacturing of a dispenser in a machine capable of producing certain dispensers with an inside bag or add bags to an existing dispenser.

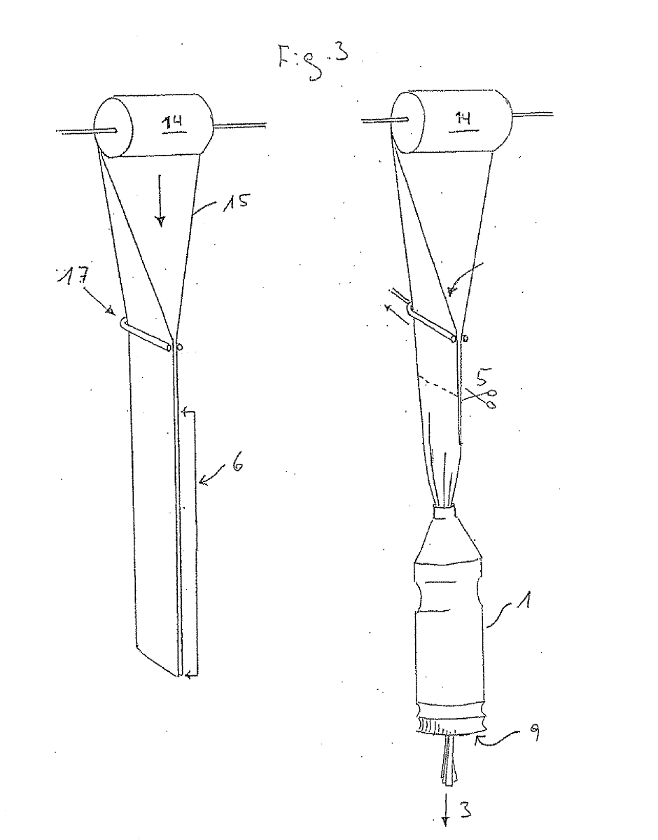

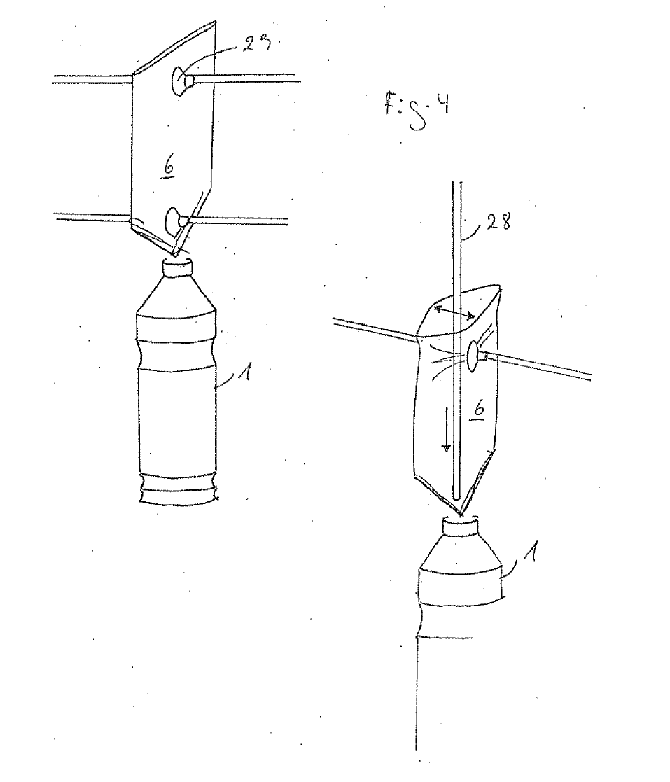

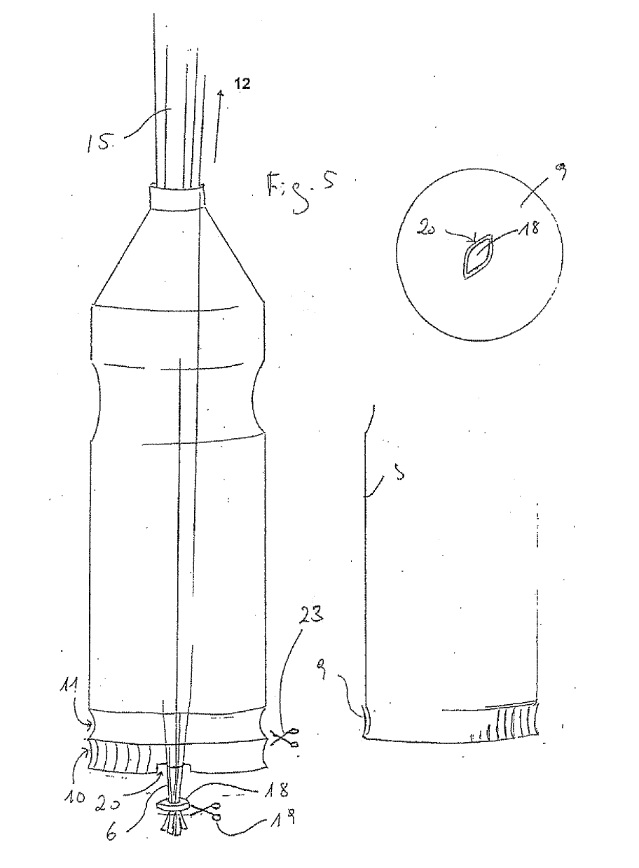

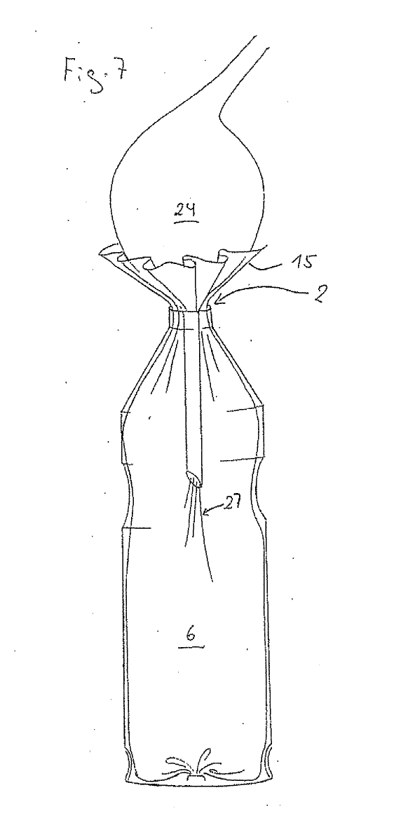

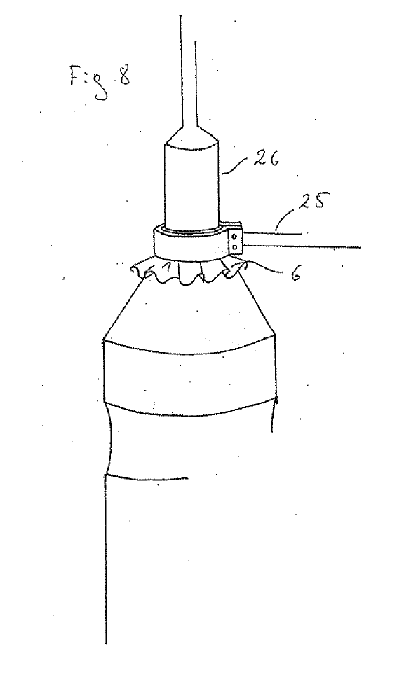

The machine is capable of performing the following tasks, which is also illustrated in FIG. 3-7:
A roll 14 of plastic sheet 15 is mounted on the machine and when the roll of plastic sheet has been folded by a folder 17 it is continually welded 16 into a pipe shaped bag 6.
The pipe/bag 6 is pulled/pushed by a gripper/mandrel 28 or sucked by means of a pipe through the bottle bottom, which is illustrated in FIG. 4 or 5. It is also illustrated that the bag can be maintained by means of suction discs 29, if desired.
The bag is tightly gathered on the outside of the bottle bottom by means of a gripper and at the same time, clips 18 are added by melting. Superfluous bag material is removed, e.g. by cutting 19 or melting.
The bag 6 is pulled up whereby the clips 18 fits into a hole 20 in the bottom, which is formed such that the clips cannot rotate in relation to the hole 20, when the clips is placed in the hole 20.
The bottle is cut 23 at the bottom, which is illustrated in FIG. 5, while the bag 6 inside the dispenser 1 still is stretched out to avoid that the knife/scissors hit the bag.
The bottom is attached to the bottle again, and the ring-shaped beadb/profile 10 encloses the bead/profile 11 as a snap lock, which is illustrated in the right side of FIG. 5.
A blower is inserted through the bag 6 top at the bottle 1 upper opening 2, as illustrated in FIG. 7. The inserted blower 24 blows 27 air into the bag 6 to expand the bag and fill out the bottle completely.
The bag 6 can be expanded in an alternative manner, e.g. by means of vacuum or by means of a balloon.
Subsequently, a gripper 25 pushes the bag over the bottle neck's sides and maintains the bag.
The blower 24 is removed.
A hot mandrel is inserted into a bottle neck and melts the bag 6 together with the bottle neck. Superfluous plastic is melted/cut at the same time.
The gripper can possibly appear as a template providing the bottle neck by heating with a thread corresponding to the lid.

Hereafter, the bottle is ready to charge and can be provided with a lid/spout.

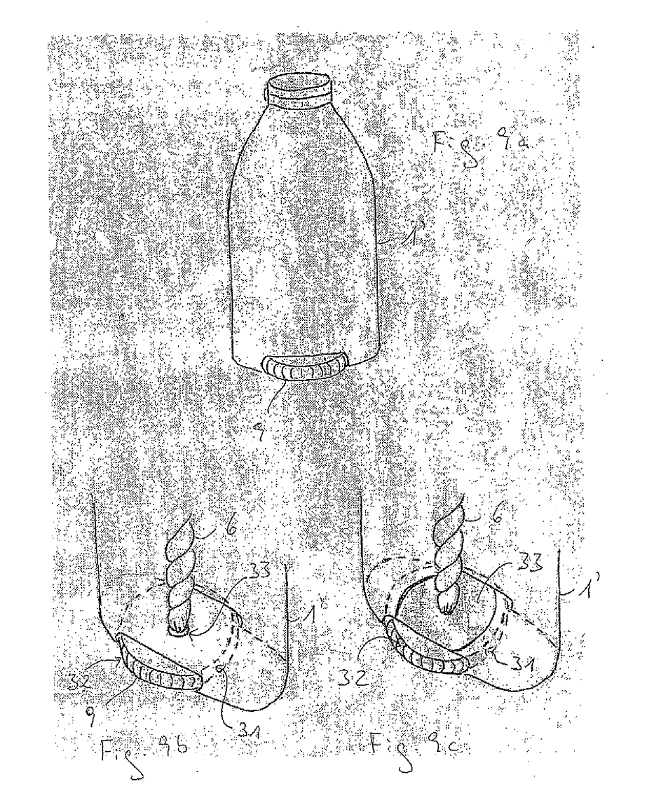

The dispenser does not need to be cylindrical even though it appears cylindrical. As an alternative, the bottle can be oval-shaped as shown in FIG. 9a, where the bottle 1′ comprises an notch/recess with a bead/profile 31 interacting by enclosure with a rotatable end piece 9 with opposite bead/profile 31, which end piece is provided inside the bead/profile 31. The bag extends through the opening 33 in the bottle's 1′ bottom and is also attached to the rotatable end piece. Such opening can be of a relatively small diameter as shown in FIG. 9b or be of a relatively large diameter as shown in FIG. 9c.

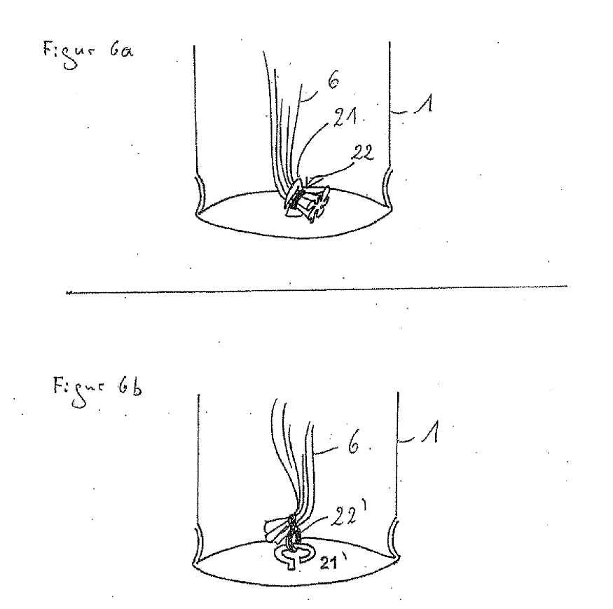

The bag can be attached to the bottle's 6 bottom by means of a hook 21 on the inside, which is shown as an alternative in FIG. 6a, where the hook 21 holds back a ring 22. As an alternative, as shown in FIG. 6h, the bag can be provided with a ring 22′, which is attached to a hook 21′.

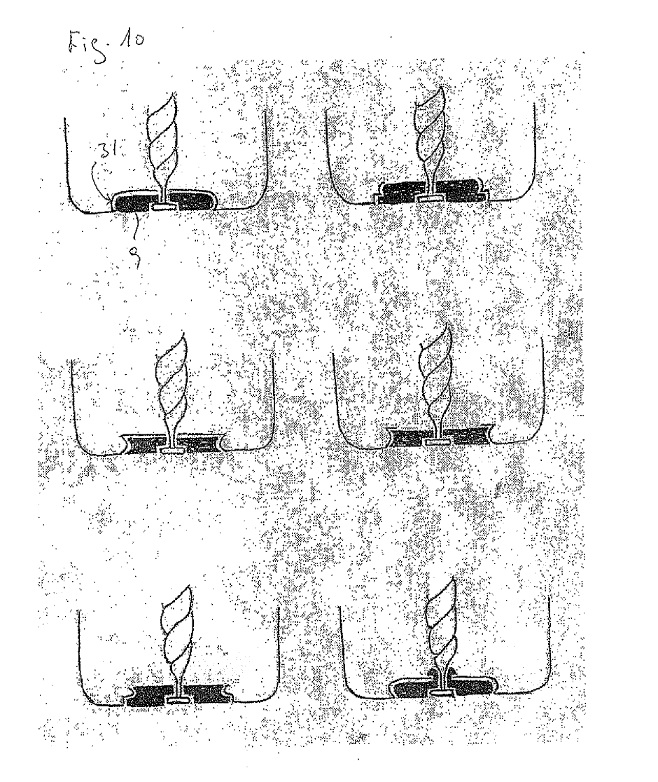

FIG. 10 shows a line of alternative recess embodiments with an enclosing bead/profile 31 interacting by enclosure with an end piece 9 matching the bead/profile 32, which end piece is provided inside the bead/profile 31.

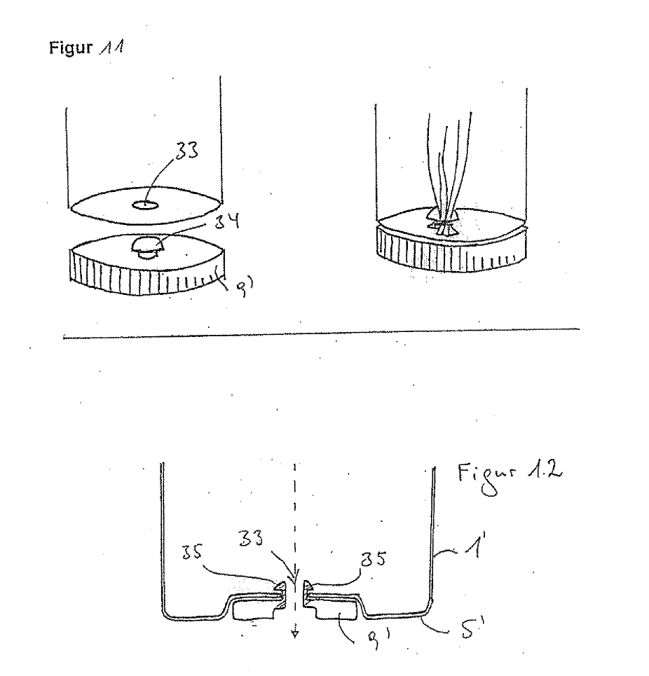

FIG. 11 shows an alternative embodiment. The bottle 1 is provided with a turning wheel 9′, which by means of a fungus-shaped snap lock 34 is attached in a bole 33 in the centre of the bottle's 1 bottom. To attach a bag inside the bottle, the same procedure described for the cylindrical model is applied; likewise the bag 6 can be attached to the bottom cf. FIG. 6a.

FIG. 12 shows an alternative embodiment according to the invention. The dispenser wall 5′, e.g. with a circular or oval-shaped cross section, is in this case provided with a lower opening 33 and the rotatable end piece 9′ is provided with a circular profile in the shape of a rotation-symmetrical, ring-shaped barb/bead 35, which can be inserted into the lower opening 33. The elastic force between the bead 35, which is shown as a cross section, and the dispenser wall cause a friction, which can act in opposition to untwisting of the bag after use. According to an alternative shape, this profile is divided into two by slitting or divided into four to ease insertion.

1. Method for manufacturing of a dispenser, the method comprising
providing a container with an opening a at the first end and an end piece at the opposite end and with a container wall between the first and the second end, the container wall enclosing a volume,
inserting a bag into this volume in the container,
attaching the bag to the end piece,
providing the bag with an opening in the first end and attaching the bag with this open end to the opening of the container intended to extraction of material from the bag,
providing the end piece rotabably relatively to the container wall to twist the bag about its longitudinal axis by rotating the end piece in relation to the container wall, characterised in that
the end piece is provided with a radially inward or outward directed ring-shape profile,
the end piece by elastic deformation is squeezed together with the container wall in such a manner that its profile interacts with the complementary profile or opening of the container wall and hence is arranged to maintain the end piece rotatable to the container wall.

2. Method according to claim 1 characterised in that the container is provided with two complementary, inward or outward directed, ring-shaped profiles in continuation of each other in the container wall and that a closing bottom in continuation of the profiles is provided and that the end piece is released from the rest of the container such that the container is provided with a container wall with one of the profiles and an end piece is provided with the bottom and the other complementary profiler where the end piece by elastic deformation is pressed together with the complementary profile of the container wall and is arranged to rotatably maintain the end piece to the container wall.

3. Method according to claim 2 characterised in that the end piece is released from the rest of the container wall by cutting, while the bag is outstretched in the container to give great distance to the container wall during cuffing.

4. Method according to claim 1 characterised in that a smaller friction coefficient is provided between the bag and the inner wall of the container at the end piece than at a distance from the end piece.

5. Method according to claim 1 characterised in that air is blown into the bag to press the bag against the containers inner wall before the bag opening is attached to the container opening.

6. Method according to claim 1 characterised in that the bag is provided with a diameter which roughly corresponds to the diameter of the container opening and the bag is inserted into the container, whereupon the bag in the container is heated up and gas is blown into the bag to expand the bag against the container inner wall under heat.

7. Method according to claim 1 characterised in that the container is provided with a plastic molding.

8. Method according to claim 1 characterised in that the bag is attached to the container's first end over an extension which is larger than the extension of the attachment at the end piece.

9. Method according to claim 1 characterised in that the bag is inserted after manufacturing of the container.

10. Dispenser for viscous materials, where the dispenser comprises a container comprising a bag of flexible material, where the bag has an opening in one end, which is attached to an opening in the container for extraction of the material from the bag, where the container has an end piece in the opposite end and an enclosing container wall between the two ends, where the end piece is rotatable in relation to the container wall and where the other end of the bag is attached to the end piece with fastening means such that the bag, when the end pieces are rotated in relation to the container wall, is twisted about its longitudinal axis characterised in that the end piece has a radially inward or outward directed, ring-shaped profile and that the container wall has a profile or a ring-shaped opening, which is complementary in relation to the ring-shaped profile of the end piece and that the profile of the end piece interacts with the container wall complementary profile or opening and is arranged to maintain the end piece rotatable to the container wall.

11. Dispenser according to claim 10 characterised in that the dispenser in a pre-active state comprises a container wall having two radially inward or outward directed, ring-shaped profiles in continuation of each other and a bottom in continuation of the profiles and where the container in an active state has an end piece with a ring-shaped profile and a container wall with a complementary ring-shaped profile, where the end piece profile interacts with the container wall profile to maintain the end piece rotatable to the container wall.

12. Dispenser according to claim 10 characterised in that the bag is attached to the container's first end over an extension larger than the extension of the attachment at the end piece.

13. Dispenser according to claim 10 characterised in that the dispenser is provided with a friction coefficient, which is smaller between the container inner wall at the end piece in a distance from the end piece.

14. Dispenser according to claim 13 characterised in that the bag material in one end is arranged to have a cross section, which under atmospheric pressure is at least as large as the inner cross section of the container such that the bag when filled up can abut against the inner side of the container.

15. Dispenser according to claim 14 characterised in that the bag material is arranged to comprise a volume under atmospheric pressure, which volume is equal to or larger than the inside volume of the container.

16. Dispenser according to claim 15 characterised in that the fastening means are arranged to maintain the bag over an extension less than the extension of the bag at its upper attachment around the container opening.

17. Dispenser according to claim 1 characterised in that the dispenser has an oval-shaped cross section.

18. Dispenser according to claim 17 characterised in that the container wall has recesses with a bead/profile enclosing an end piece inside the bead/profile and interacts with a corresponding bead/profile.
